(19) United States
(12) Patent Application Publication
(10) Pub. No.: US 2019/0086786 A1
(43) Pub. Date: Mar. 21, 2019

(54) PROJECTION MEMBER, PROJECTION SYSTEM, METHOD OF MANUFACTURING PROJECTION MEMBER

(71) Applicant: FUJIFILM Corporation, Tokyo (JP)

(72) Inventors: Shunya Katoh, Ashigara-kami-gun (JP); Mitsuyoshi Ichihashi, Ashigara-kami-gun (JP); Shigeaki Nimura, Ashigara-kami-gun (JP)

(73) Assignee: FUJIFILM Corporation, Tokyo (JP)

(21) Appl. No.: 16/191,897

(22) Filed: Nov. 15, 2018

Related U.S. Application Data
(63) Continuation of application No. PCT/JP2017/017683, filed on May 10, 2017.

(30) Foreign Application Priority Data
May 18, 2016 (JP) 2016-099662

(51) Int. Cl. G03B 21/604; G02B 5/30

(52) U.S. Cl. CPC G03B 21/604; G02B 5/3016

(57) ABSTRACT

Provided are a projection member in which a change in tint depending on a projection position is suppressed, a projection system, and a method of manufacturing the projection member. A projection member according to an embodiment of the present invention includes a reflecting layer that is obtained by immobilizing a cholesteric liquid crystalline phase, in which a helical pitch of the cholesteric liquid crystalline phase gradually changes in a plane direction of the reflecting layer.

### CROSS-REFERENCE TO RELATED APPLICATIONS

This application is a Continuation of PCT International Application No. PCT/JP2017/017683 filed on May 10, 2017, which claims priority under 35 U.S.C. § 119(a) to Japanese Patent Application No. 2016-099662 filed on May 18, 2016. The above application is hereby expressly incorporated by reference, in its entirety, into the present application.

### BACKGROUND OF THE INVENTION

### 1. Field of the Invention

The present invention relates to a projection member, a projection system, and a method of manufacturing the projection member.

### 2. Description of the Related Art

A layer obtained by immobilizing a cholesteric liquid crystalline phase is known as a layer having properties in which at least either right circularly polarized light or left circularly polarized light in a specific wavelength range is selectively reflected. Therefore, this layer has been developed for various uses and is applicable to, for example, a projection member (JP1993-107660A (JP-H5-107660A)).

### SUMMARY OF THE INVENTION

On the other hand, in a case where the size of a projection member is large and projection is performed using a so-called keystone correction function, there is a problem in that the tint changes depending on a position of a projection surface of the projection member.

More specifically, as shown in FIG. 1, in a case where projection light is emitted from a projection device 102 to a projection member 100 that is formed of a reflecting layer of the related art obtained by immobilizing a cholesteric liquid crystalline phase, there is a problem in that a tint at an A point positioned at a center portion of a surface of the projection member 100 is different from a tint at a B point positioned at an end portion of the surface of the projection member 100.

The present invention has been made under the above-described circumstances, and an object thereof is to provide a projection member in which a change in tint depending on a projection position is suppressed.

In addition, another object of the present invention is to provide a projection system and a method of manufacturing the projection member.

The present inventors conducted a thorough investigation on the above-described objects and found that the objects can be achieved by adjusting a helical pitch of a cholesteric liquid crystalline phase in a plane direction of a reflecting layer (along a surface of the reflecting layer).

That is, it was found that the objects can be achieved by the following configurations.

(1) A projection member comprising:

a reflecting layer that is obtained by immobilizing a cholesteric liquid crystalline phase,

in which a helical pitch of the cholesteric liquid crystalline phase gradually changes in a plane direction of the reflecting layer.

(2) The projection member according to (1),

in which the helical pitch of the cholesteric liquid crystalline phase gradually increases from a center portion of the reflecting layer to an end portion of the reflecting layer.

(3) The projection member according to (1),

in which the helical pitch of the cholesteric liquid crystalline phase gradually changes from one end of the reflecting layer to another end of the reflecting layer.

(4) The projection member according to any one of (1) to (3),

in which the helical pitch of the cholesteric liquid crystalline phase increases on a surface of the reflecting layer as a distance from a projection light emitting opening of a projection device disposed distant from the surface of the reflecting layer increases.

(5) The projection member according to any one of (1) to (4),

in which the reflecting layer has light diffusibility.

(6) The projection member according to (5),

in which the reflecting layer includes a light diffusion element.

(7) The projection member according to any one of (1) to (6), further comprising:

a light diffusion layer that is provided on the reflecting layer.

(8) The projection member according to any one of (1) to (7),

in which a plurality of the reflecting layers having different reflection center wavelengths are provided.

(9) A projection system comprising:

the projection member according to any one of (1) to (8); and

a projection device that emits projection light to the projection member.

(10) A method of manufacturing the projection member according to any one of (1) to (8), the method comprising:

a step of forming a coating film using a composition that includes a liquid crystal compound having a polymerizable group and a chiral agent capable of changing a helical pitch of a cholesteric liquid crystalline phase in response to light, heating the coating film, and aligning the liquid crystal compound to be in a cholesteric liquid crystalline phase state;

a step of irradiating the coating film with light to change the helical pitch of the cholesteric liquid crystalline phase in a plane direction of the coating film; and

a step of curing the coating film irradiated with light to form a reflecting layer obtained by immobilizing a cholesteric liquid crystalline phase.

According to the present invention, a projection member in which a change in tint depending on a projection position is suppressed can be provided.

In addition, according to the present invention, a projection system and a method of manufacturing the projection member can also be provided.

### BRIEF DESCRIPTION OF THE DRAWINGS

FIG. 1 is a schematic diagram in a case where projection light is emitted from a projection device to a projection member of the related art.

FIG. 2 is a perspective view showing an embodiment of a projection member according to the present invention.

FIG. 3 is a side view showing an embodiment of a projection system according to the present invention.

FIG. 4 is a perspective view showing another embodiment of the projection member according to the present invention.

FIG. 5 is a side view showing still another embodiment of the projection system according to the present invention.

FIG. 6 is a perspective view showing an embodiment of a method of manufacturing the projection member according to the present invention.

FIG. 7 is a perspective view showing another embodiment of the method of manufacturing the projection member according to the present invention.

FIG. 8 is a perspective view showing still another embodiment of the method of manufacturing the projection member according to the present invention.

FIG. 9 is a perspective view showing an exposure method in Example 1.

### DESCRIPTION OF THE PREFERRED EMBODIMENTS

Hereinafter, the details of the present invention will be described. In this specification, numerical ranges represented by “to” include numerical values before and after “to” as lower limit values and upper limit values.

In this specification, for example, unless specified otherwise, an angle such as “parallel” represents that a difference from an exact angle is less than 5 degrees. The difference from an exact angle is preferably less than 4 degrees and more preferably less than 3 degrees.

In this specification, “sense” used regarding circularly polarized light represents whether the circularly polarized light is either right circularly polarized light or left circularly polarized light. In a case where light is observed such that the propagates toward the front side, the sense of circularly polarized light is defined as follows: in a case where a distal end of an electric field vector rotates clockwise along with an increase in time, the light is right circularly polarized light; and in a case where a distal end of an electric field vector rotates counterclockwise along with an increase in time, the light is left circularly polarized light.

In this specification, the term “sense” can also be used regarding a helical twisting direction of a cholesteric liquid crystalline phase. Regarding selective reflection of circularly polarized light by a cholesteric liquid crystalline phase, in a case where a helical twisting direction (sense) of the cholesteric liquid crystalline phase is right, right circularly polarized light is reflected and transmission of left circularly polarized light is allowed, and in a case where the helical twisting direction of the cholesteric liquid crystalline phase is left, left circularly polarized light is reflected and transmission of right circularly polarized light is allowed.

In addition, in this specification, “(meth)acrylate” represents both of acrylate and methacrylate, “(meth)acryloyl group” represents both of an acryloyl group and a methacryloyl group, and “(meth)acryl” represents both of acryl and methacryl.

A projection member according to an embodiment of the present invention includes a reflecting layer that is obtained by immobilizing a cholesteric liquid crystalline phase, in which a helical pitch of the cholesteric liquid crystalline phase gradually changes in a plane direction of the reflecting layer (along a surface of the reflecting layer).

As described above, in the related art, there is a problem in that a tint changes depending on a position (projection position) of a projection surface of the projection member. The present inventors conducted an investigation on the reason for the problem and found that the reason is that a wavelength of light that is reflected from a reflecting layer obtained by immobilizing a cholesteric liquid crystalline phase varies depending on an incidence angle of projection light.

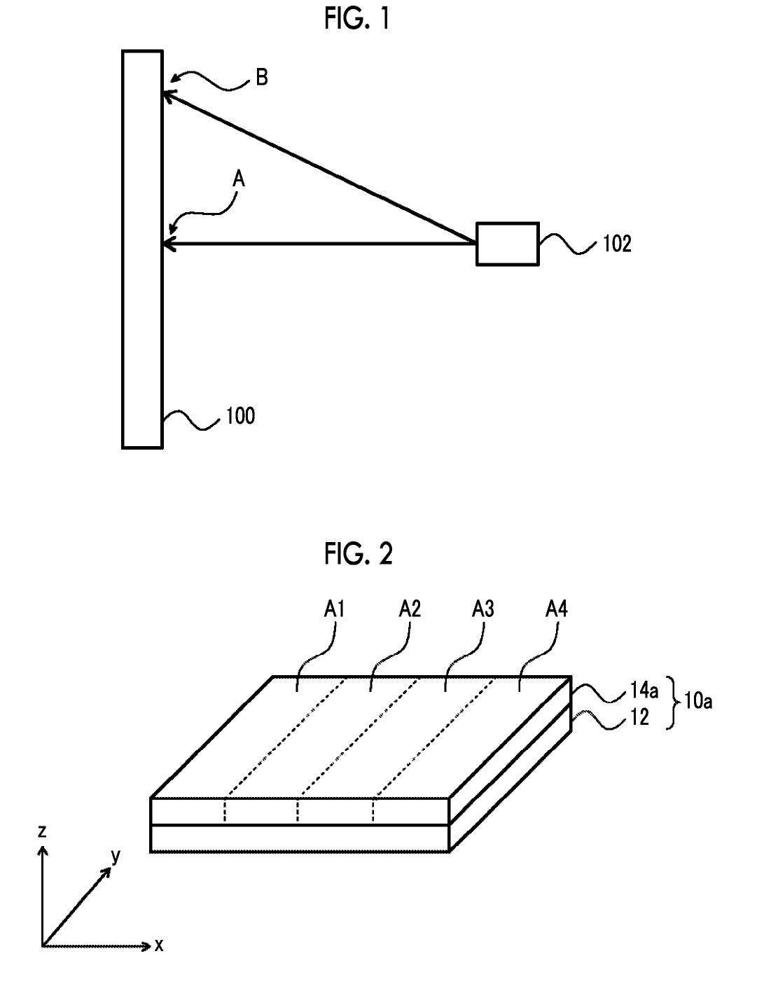

More specifically, a projection member 100 of the related art shown in FIG. 1 is formed of a reflecting layer that is obtained by immobilizing a cholesteric liquid crystalline phase having substantially the same helical pitch over the entire region. At the A point of the projection member 100, projection light is incident substantially parallel to a normal direction perpendicular to the surface of projection member 100. Therefore, light at a predetermined reflection center wavelength derived from the helical pitch of the cholesteric liquid crystalline phase is reflected. On the other hand, at the B point of the projection member 100, projection light which forms a predetermined angle with respect to the normal direction perpendicular to the surface of the projection member 100 is incident. Therefore, light at a wavelength which deviates from the reflection center wavelength at the A point is reflected. The reason for this is that, in a case where an incidence direction of light is incident from a normal direction perpendicular to the layer surface, a wavelength of light reflected from the reflecting layer obtained by immobilizing a cholesteric liquid crystalline phase tends to be shifted to the short wavelength side.

As a result, there is a problem in that a tint at the A point is different a tint at the B point.

On the other hand, in the projection member according to the embodiment of the present invention, the helical pitch of the cholesteric liquid crystalline phase in the plane direction of the reflecting layer is adjusted. As a result, light substantially at the same wavelength is reflected at any position of the reflecting layer surface, and thus a desired effect is obtained. More specifically, for example, the helical pitch of the cholesteric liquid crystalline phase increases on a surface of the reflecting layer as a distance from a projection light emitting opening of a projection device disposed distant from the surface of the reflecting layer increases. As a result, the above-described effect is obtained. In other words, by increasing the helical pitch of the cholesteric liquid crystalline phase at a position where an incidence angle of projection light is large with respect to a normal direction perpendicular to the surface of the reflecting layer, the reflection center wavelength at the position is increased to be adjusted such that a tint of light reflected from the entire area of the reflecting layer is the same.

Hereinafter, the projection member according to the embodiment of the present invention will be described with reference to the drawings.

FIG. 2 is a perspective view showing an embodiment of a projection member according to the present invention.

A projection member 10a shown in FIG. 2 includes a substrate 12 and a reflecting layer 14a disposed on the substrate 12. The reflecting layer 14a is a layer obtained by immobilizing a cholesteric liquid crystalline phase. The reflecting layer 14a includes four regions (regions A1 to A4) having different sizes (lengths) of helical pitches of cholesteric liquid crystalline phases, and the helical pitch of the cholesteric liquid crystalline phase in each of the regions gradually increases (lengthens) in an x-axis direction. That is, a relationship represented by the following Expression (1) is satisfied.

Helical Pitch of Cholesteric Liquid Crystalline Phase in Region A4>Helical Pitch of Cholesteric Liquid Crystalline Phase in Region A3>Helical Pitch of Cholesteric Liquid Crystalline Phase in Region A2>Helical Pitch of Cholesteric Liquid Crystalline Phase in Region A1 Expression (1):

In general, a reflection center wavelength λ (nm) of the reflecting layer depends on a pitch P (=helical cycle) of a helical structure in the cholesteric liquid crystalline phase and complies with a relationship of λ=n×P with an average refractive index n of the reflecting layer. In this specification, the reflection center wavelength λ of the reflecting layer refers to a wavelength at a gravity center position of a reflection peak in a circularly polarized light reflection spectrum measured from a normal direction perpendicular to the reflecting layer. As can be seen from the expression, the reflection center wavelength λ can be adjusted by adjusting the pitch length of the helical structure.

Accordingly, in the reflecting layer 14a, the reflection center wavelength λ of each of the regions A1 to A4 satisfies a relationship represented by the following Expression (2).

Reflection Center Wavelength λ in Region A4>Reflection Center Wavelength λ in Region A3>Reflection Center Wavelength λ in Region A2>Reflection Center Wavelength λ in Region A1 Expression (2):

That is, the reflection center wavelength λ gradually increases from the region A1 to the region A4.

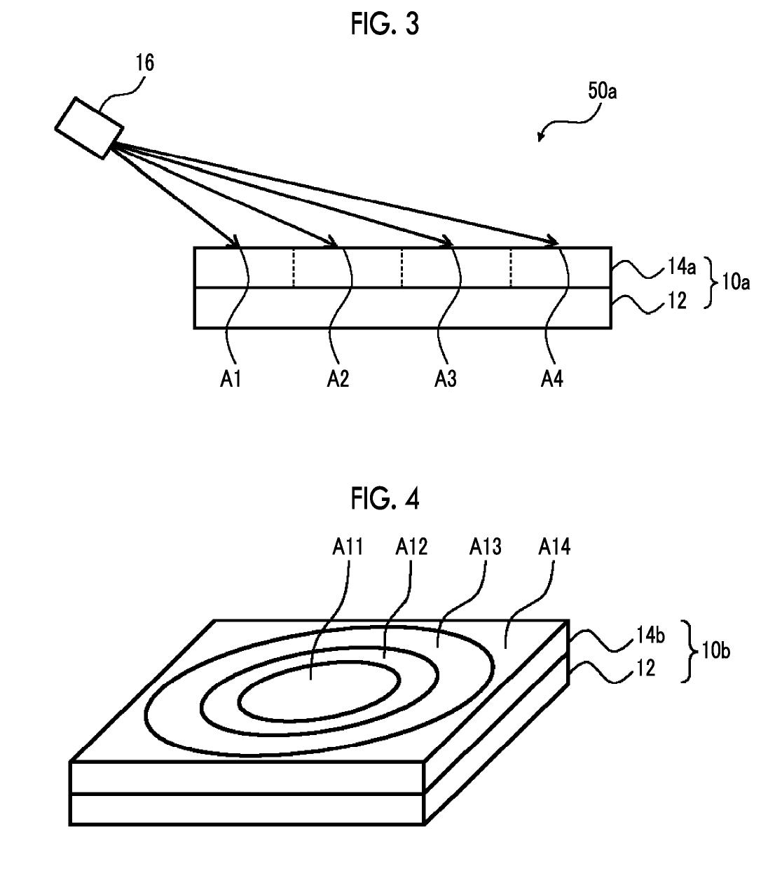

FIG. 3 is a side view showing a projection system 50a including the projection member 10a.

The projection system 50a includes: the projection member 10a; and a projection device 16 that is disposed distant from the surface of the reflecting layer 14a of the projection member 10a. The projection device 16 is disposed to be biased to one end side of the projection member 10a.

As shown in FIG. 3, projection light is emitted from the projection light emitting opening (not shown) of the projection device 16 to the reflecting layer 14a of the projection member 10a. At this time, the projection light emitted from the projection light emitting opening of the projection device 16 is incident at a predetermined angle with respect to each of the regions A1 to A4. As shown in FIG. 3, the incidence angle of the projection light with respect to (0 degrees) a normal direction perpendicular to the surface of the reflecting layer 14a increases from the region A1 to the region A4. In other words, the distance from the projection light emitting opening of the projection device increases from the region A1 to the region A4.

As described above, the wavelength of light reflected at a position where the incidence angle of the projection light is large (a position where the distance from the projection light emitting opening of the projection device is long) becomes shorter than the reflection center wavelength.

On the other hand, in the projection member 10a, the helical pitch of the cholesteric liquid crystalline phase is adjusted to increase from the region A1 to the region A4, and the reflection center wavelength increases from the region A1 to the region A4. Therefore, for example, the reflection center wavelength of the region A2 is longer than the reflection center wavelength of the region A1, but the incidence angle of projection light emitted from the projection device 16 in the region A2 is larger than that in the region A1. The wavelength of light reflected from the region A2 is shorter than the reflection center wavelength of region A2. As a result, the wavelength of light reflected from the region A2 is substantially the same as the wavelength of light reflected from the region A1. Regarding the region A3 and the region A4, the same phenomenon as described occurs.

Therefore, the wavelength of light reflected from each of the regions A1 to A4 of the reflecting layer 14a is substantially the same. As a result, at any position of the surface of the reflecting layer 14a, a tint of a projection image is substantially the same.

FIG. 4 shows a perspective view showing another embodiment of the projection member according to the present invention.

A projection member 10b shown in FIG. 4 includes a substrate 12 and a reflecting layer 14b disposed on the substrate 12. The reflecting layer 14b is a layer obtained by immobilizing a cholesteric liquid crystalline phase.

The projection member 10b and the projection member 10a are different from each other in the disposition of regions having different helical pitches in the reflecting layer. As shown in FIG. 4, the reflecting layer 14b includes four regions (regions A11 to A14) having different sizes of helical pitches of cholesteric liquid crystalline phases, and the helical pitch of the cholesteric liquid crystalline phase in each of the regions gradually increases from a center portion of the reflecting layer 14b to an end portion of the reflecting layer 14b. That is, the helical pitch of the cholesteric liquid crystalline phase in each of the regions A11 to A14 satisfies a relationship represented by the following Expression (3).

Helical Pitch of Cholesteric Liquid Crystalline Phase in Region A14>Helical Pitch of Cholesteric Liquid Crystalline Phase in Region A13>Helical Pitch of Cholesteric Liquid Crystalline Phase in Region A12>Helical Pitch of Cholesteric Liquid Crystalline Phase in Region A11 Expression (3):

Accordingly, in the reflecting layer 14b, the reflection center wavelength λ of each of the regions A11 to A14 satisfies a relationship represented by the following Expression (4).

Reflection Center Wavelength λ in Region A14>Reflection Center Wavelength λ in Region A13>Reflection Center Wavelength λ in Region A12>Reflection Center Wavelength λ in Region A11 Expression (4):

That is, the reflection center wavelength λ gradually increases from the region A11 to the region A14.

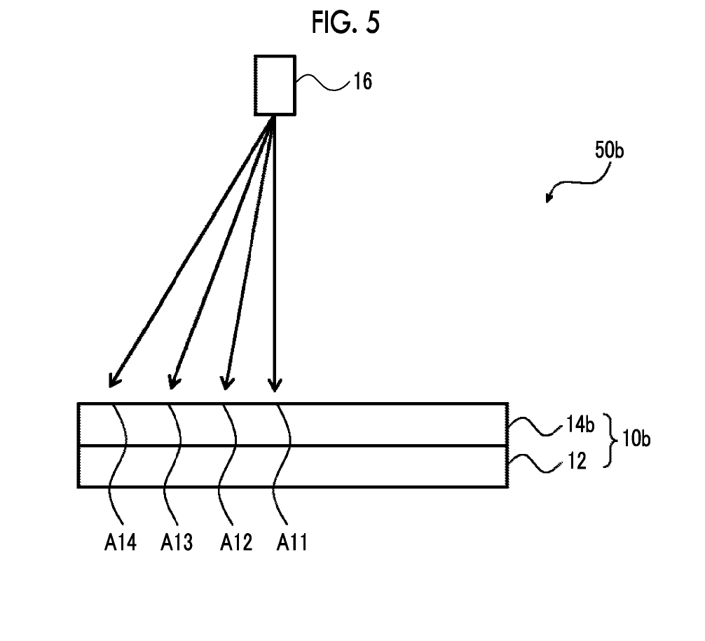

FIG. 5 is a side view showing a projection system 50b including the projection member 10b.

The projection system 50b includes: the projection member 10b; and the projection device 16 that is disposed distant from the surface of the reflecting layer 14b of the projection member 10b. The projection device 16 is disposed at a position opposite to the projection member 10b.

As shown in FIG. 5, projection light is emitted from the projection light emitting opening (not shown) of the projection device 16 to the reflecting layer 14b of the projection member 10b. At this time, the projection light emitted from the projection light emitting opening of the projection device 16 is incident at a predetermined angle with respect to each of the regions A11 to A14. As shown in FIG. 5, the incidence angle of the projection light with respect to a normal direction perpendicular to the surface of the reflecting layer 14b increases from the region A11 to the region A14. In other words, the distance from the projection light emitting opening of the projection device 16 increases from the region A11 to the region A14.

On the other hand, in the projection member 10b, as in the case of the projection member 10a, the helical pitch of the cholesteric liquid crystalline phase is adjusted to increase from the region A11 to the region A14, and the reflection center wavelength increases from the region A11 to the region A14. Accordingly, even in the projection system 50b, as in the case of the configuration shown in FIG. 3, the wavelengths of light components reflected from the regions A11 to A14 of the reflecting layer 14b are substantially the same, and a tint is substantially the same at any position.

FIG. 2 shows the configuration in which the helical pitch of the cholesteric liquid crystalline phase changes from one end of the reflecting layer 14a to another end of the reflecting layer 14a, and FIG. 4 shows the configuration in which the helical pitch of the cholesteric liquid crystalline phase increases from the center portion of the reflecting layer 14b to the end portion of the reflecting layer 14b. However, the present invention is not limited to these configurations. In the present invention, the reflecting layer only has to include a region in which the helical pitch of the cholesteric liquid crystalline phase gradually changes in a plane direction of the reflecting layer (along the surface of the reflecting layer). That is, the reflecting layer may include a region where the helical pitch does not gradually change as long as at least a portion of the reflecting layer includes a region where the helical pitch of the cholesteric liquid crystalline phase gradually changes in a plane direction of the reflecting layer. For example, a configuration may be adopted in which the helical pitch of the cholesteric liquid crystalline phase gradually changes from one end of the reflecting layer to the center portion of the reflecting layer and does not change from the center portion of the reflecting layer to another end of the reflecting layer.

In addition, FIGS. 2 to 4 show the configurations in which the helical pitch of the cholesteric liquid crystalline phase changes stepwise. However, the present invention is not limited to these configurations. For example, a configuration the helical pitch continuously changes may be adopted. More specifically, a configuration in which the helical pitch of the cholesteric liquid crystalline phase continuously changes from one end of the reflecting layer 14a to another end of the reflecting layer 14a, or a configuration in which the helical pitch of the cholesteric liquid crystalline phase continuously changes from the center portion of the reflecting layer 14b to the end portion of the reflecting layer 14b may be adopted.

In addition, in FIGS. 2 and 4, the reflecting layer including the four regions has been described. However, the present invention is not limited to this configuration. For example, a configuration in which the reflecting layer includes two or three regions having different helical pitches of cholesteric liquid crystalline phases, or a configuration in which the reflecting layer includes five or more regions having different helical pitches of cholesteric liquid crystalline phases may be adopted.

Hereinafter, each of the members constituting the projection member and the projection system will be described in detail.

<Substrate>

The substrate is a plate that supports the reflecting layer. The substrate may not include the projection member and is an optional component.

It is preferable that the substrate is a transparent substrate. The transparent substrate refers to a substrate in which a transmittance of visible light is 60% or higher, and the transmittance is preferably 80% or higher and more preferably 90% or higher.

A material constituting the substrate is not particularly limited, and examples thereof include a cellulose polymer, a polycarbonate polymer, a polyester polymer, a (meth)acrylic polymer, a styrene polymer, a polyolefin polymer, a vinyl chloride polymer, an amide polymer, an imide polymer, a sulfone polymer, a polyethersulfone polymer, and a polyether ether ketone polymer.

The substrate may include various additives such as an ultraviolet (UV) absorber, matting agent particles, a plasticizer, a deterioration inhibitor, or a release agent.

It is preferable that the substrate has low birefringence in a visible range. For example, a phase difference (in-plane retardation) of the substrate at a wavelength of 550 nm is preferably 50 nm or less and more preferably 20 nm or less.

The substrate may have a curved surface. In addition, the substrate may have a concave shape or a convex shape.

The thickness of the substrate is not particularly limited and is preferably 10 to 200 μm and more preferably 20 to 100 μm from the viewpoint of reduction in thickness and handleability.

The thickness refers to the average thickness and can be obtained by measuring thicknesses of any five points of the substrate and obtaining the average value thereof.

<Reflecting Layer>

The reflecting layer is a layer obtained by immobilizing a cholesteric liquid crystalline phase.

The cholesteric liquid crystalline phase has circularly polarized light selective reflecting properties that selectively reflect either right circularly polarized light or left circularly polarized light.

The layer obtained by immobilizing a cholesteric liquid crystalline phase may be a layer in which the alignment of the liquid crystal compound as a cholesteric liquid crystalline phase is immobilized. In this specification, the layer obtained by immobilizing a cholesteric liquid crystalline phase may also be referred to as “cholesteric liquid crystalline layer”. It is preferable that the cholesteric liquid crystalline layer is a layer obtained by aligning a cholesteric liquid crystalline phase of a polymerizable liquid crystal compound (liquid crystal compound having a polymerizable group) and then curing the aligned polymerizable liquid crystal compound by light irradiation or the like.

Here, the state where a cholesteric liquid crystalline phase is “immobilized” refers to a state in which the alignment of the liquid crystal compound as the cholesteric liquid crystalline phase is immobilized. More specifically, it is preferable that the state where the cholesteric liquid crystalline phase is “immobilized” is a state where the immobilized alignment state can be stably maintained without being fluid and being changed by an external field or an external force in a temperature range of typically 0° C. to 50° C., more strictly, −30° C. to 70° C.

The cholesteric liquid crystalline layer is not particularly limited as long as the optical characteristics of the cholesteric liquid crystalline phase are maintained, and the liquid crystal compound in the layer does not necessarily exhibit liquid crystallinity. For example, the molecular weight of the polymerizable liquid crystal compound may be increased by a curing reaction such that the liquid crystallinity thereof is lost.

In general, in terms of shape, the liquid crystal compound can be classified into a rod-shaped type (rod-shaped liquid crystal compound) and a discotic type (discotic liquid crystal compound). Further, each of the rod-shaped type and the discotic type can be classified into a low molecular weight type and a polymer type. In general, the polymer refers to a compound having a polymerization degree of 100 or higher (Polymer Physics-Phase Transition Dynamics, Masao Doi, page 2, Iwanami Shoten Publishers, 1992) In the present invention, any liquid crystal compound can also be used. In addition, two or more liquid crystal compounds may also be used in combination.

The liquid crystal compound may have a polymerizable group. The kind of the polymerizable group is not particularly limited, and a functional group capable of an addition polymerization reaction is preferable, and a polymerizable ethylenically unsaturated group or a ring polymerizable group is preferable. More specifically, as the polymerizable group, a (meth)acryloyl group, a vinyl group, a styryl group, an allyl group, an epoxy group, or an oxetane group is preferable, and a (meth)acryloyl group is more preferable.

Examples of the liquid crystal compound include a polymerizable rod-shaped liquid crystal compound. More specifically, compounds described in Makromol. Chem., Volume 190, page 2255 (1989), Advanced Materials Volume 5, page 107 (1993), U.S. Pat. Nos. 4,683,327A, 5,622,648A, 5,770,107A, WO95/022586A, WO95/024455A, WO97/000600A, WO98/023580A, WO98/052905A, WO2008/133290A, JP1989-272551A (JP-H1-272551A), JP1994-016616A (JP-H6-016616A), JP1995-110469A (JP-H7-110469A), JP1999-080081A (JP-H11-080081A), JP2001-64627, JP2010-74759, JP2010-141468, JP2008-019240A, JP2013-166879A, JP2014-198814A, and JP2014-198815A can be used.

The sense of reflected circularly polarized light of the cholesteric liquid crystalline layer matches with the helical sense. Therefore, as the cholesteric liquid crystalline layer, a cholesteric liquid crystalline layer in which the helical sense is either right or left may be used.

As a method of measuring a helical sense and a helical pitch, a method described in “Introduction to Experimental Liquid Crystal Chemistry”, (the Japanese Liquid Crystal Society, 2007, Sigma Publishing Co., Ltd.), p. 46, and “Liquid Crystal Handbook” (the Editing Committee of Liquid Crystal Handbook, Maruzen Publishing Co., Ltd.), p. 196 can be used.

The layer obtained by immobilizing a cholesteric liquid crystalline phase exhibits circularly polarized light selective reflecting properties derived from the helical structure of the cholesteric liquid crystalline phase. The reflection center wavelength λ of circularly polarized light complies with the relationship of λ=n×P. Therefore, the wavelength at which the circularly polarized light selective reflecting properties are exhibited can be adjusted by adjusting the pitch of the helical structure.

That is, by adjusting the n value and the P value, the reflection center wavelength λ can be adjusted in a range of 780 to 2500 nm in order to selectively reflect either right circularly polarized light or left circularly polarized light in, for example, at least a part of a near infrared wavelength range.

In addition, the reflection center wavelength λ can be adjusted in a range of 380 to 780 nm in order to selectively reflect either right circularly polarized light or left circularly polarized light in, for example, at least a part of a visible wavelength range.

Further, the reflection center wavelength λ can be adjusted in a range of 10 to 380 nm in order to selectively reflect either right circularly polarized light or left circularly polarized light in, for example, at least a part of an ultraviolet wavelength range.

The helical pitch of the cholesteric liquid crystalline phase depends on the kind of a chiral agent which is used in combination of a liquid crystal compound, or the concentration of the chiral agent added. Therefore, a desired pitch can be obtained by adjusting the kind and concentration of the chiral agent.

The reflecting layer may include a compound other than the liquid crystal compound.

For example, the reflecting layer may include a chiral agent. The kind of the chiral agent is not particularly limited. The chiral agent may be liquid crystalline or amorphous. The chiral agent can be selected from various well-known chiral agents (for example, Liquid Crystal Device Handbook (No. 142 Committee of Japan Society for the Promotion of Science, 1989), Chapter 3, Article 4-3, chiral agent for twisted nematic (TN) or super twisted nematic (STN), p. 199). In general, the chiral agent has an asymmetric carbon atom. However, an axially asymmetric compound or a surface asymmetric compound not having an asymmetric carbon atom can also be used as a chiral agent. Examples of the axially asymmetric compound or the surface asymmetric compound include binaphthyl, helicene, paracyclophane, and derivatives thereof. The chiral agent may include a polymerizable group.

As the chiral agent, one kind may be used alone, or two or more kinds may be used in combination.

As described below, in a case where the size of the helical pitch of the cholesteric liquid crystalline phase is controlled by light irradiation during the formation of the reflecting layer, a chiral agent capable of changing the helical pitch of the cholesteric liquid crystalline phase in response to light (hereinafter, also referred to as “photosensitive chiral agent”) is preferably used.

The photosensitive chiral agent is a compound that absorbs light to change the structure and can change the helical pitch of the cholesteric liquid crystalline phase. As this compound, a compound that causes at least one of a photoisomerization reaction, a photodimerization reaction, or a photodegradation reaction to occur is preferable.

The compound that causes a photoisomerization reaction to occur refers to a compound that causes stereoisomerization or structural isomerization to occur due to the action of light. Examples of the photoisomerizable compound include an azobenzene compound and a spiropyran compound.

In addition, the compound that causes a photodimerization reaction to occur refers to a compound that causes an addition reaction between two groups for cyclization by light irradiation. Examples of the photodimerizable compound include a cinnamic acid derivative, a coumarin derivative, a chalcone derivative, and a benzophenone derivative.

Examples of the photosensitive chiral agent include a chiral agent represented by the following Formula (I). This chiral agent can change an aligned structure such as the helical pitch (twisting force, helical twist angle) of the cholesteric liquid crystalline phase according to the light amount during light irradiation.

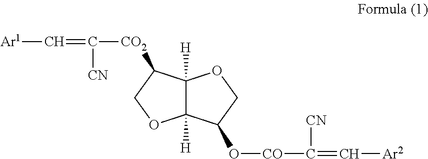

In Formula (I), Ar1 and Ar2 represents an aryl group or a heteroaromatic ring group.

The aryl group represented by Ar¹ and Ar² may have a substituent and has preferably 6 to 40 carbon atoms in total and more preferably 6 to 30 carbon atoms in total. As the substituent, for example, a halogen atom, an alkyl group, an alkenyl group, an alkynyl group, an alkoxy group, a hydroxyl group, an acyl group, an alkoxycarbonyl group, an aryloxycarbonyl group, an acyloxy group, a carboxyl group, a cyano group, or a heterocyclic group is preferable, and a halogen atom, an alkyl group, an alkenyl group, an alkoxy group, a hydroxyl group, an acyloxy group, an alkoxycarbonyl group, or an aryloxycarbonyl group is more preferable.

Among these aryl group, an aryl group represented by the following Formula (III) or (IV) is preferable.

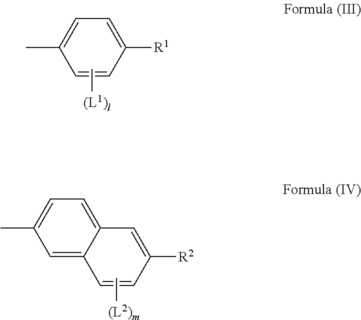

R¹ in Formula (III) and R² in Formula (IV) each independently represent a hydrogen atom, a halogen atom, an alkyl group, an alkenyl group, an alkynyl group, an aryl group, a heterocyclic group, an alkoxy group, a hydroxyl group, an acyl group, an alkoxycarbonyl group, an aryloxycarbonyl group, an acyloxy group, a carboxyl group, or a cyano group. Among these, a hydrogen atom, a halogen atom, an alkyl group, an alkenyl group, an aryl group, an alkoxy group, a hydroxyl group, an alkoxycarbonyl group, an aryloxycarbonyl group, or an acyloxy group is preferable, an alkoxy group, a hydroxyl group, or an acyloxy group is more preferable.

L¹ in Formula (III) and L² in Formula (IV) each independently represent a halogen atom, an alkyl group, an alkoxy group, or a hydroxyl group and preferably an alkoxy group having 1 to 10 carbon atoms or a hydroxyl group.

1 represents an integer of 0 or 1 to 4 and preferably 0 or 1. m represents an integer of 0 or 1 to 6 and preferably 0 or 1. In a case where l and m represent 2 or more, L¹ and L² represent different groups.

The heteroaromatic ring group represented by Ar¹ and Ar² may have a substituent and has preferably 4 to 40 carbon atoms and more preferably 4 to 30 carbon atoms. As the substituent, for example, a halogen atom, an alkyl group, an alkenyl group, an alkynyl group, an aryl group, an alkoxy group, a hydroxyl group, an acyl group, an alkoxycarbonyl group, an aryloxycarbonyl group, an acyloxy group, or a cyano group is preferable, and a halogen atom, an alkyl group, an alkenyl group, an aryl group, an alkoxy group, or an acyloxy group is more preferable.

Examples of the heteroaromatic ring group include a pyridyl group, a pyrimidinyl group, a furyl group, and a benzofuranyl group. Among these, a pyridyl group or a pyrimidinyl group is preferable.

The reflecting layer may have light diffusibility. The light diffusibility refers to a property in which light incident on the reflecting layer is reflected in a wide range. In a case where the reflecting layer has light diffusibility, an image projected to the projection member surface can be recognized from various directions.

Examples of a configuration of the reflecting layer having light diffusibility include a reflecting layer including a light diffusion element. Examples of the light diffusion element include organic particles, inorganic particles, and bubbles. Examples of a material including the organic particles a styrene resin, an acrylic resin, a silicone resin, a urea resin, and a formaldehyde condensate. Examples of a material constituting the inorganic particles include glass beads, silica, alumina, calcium carbonate, and a metal oxide.

Examples of another configuration of the reflecting layer having light diffusibility include a reflecting layer having alignment defects of the liquid crystal compound. In addition, examples of another configuration of the reflecting layer having light diffusibility include a reflecting layer having a structure (undulation structure) in which an angle between the helical axis of the cholesteric liquid crystalline phase and the surface of the reflecting layer periodically changes. In other words, the reflecting layer is a layer obtained by immobilizing a cholesteric liquid crystalline phase and has a stripe pattern including bright portions and dark portions derived from a cholesteric liquid crystalline phase in a cross-sectional view thereof measured with a scanning electron microscope, in which an angle between a normal line perpendicular to a line, which is formed using at least one dark portion, and the surface of the reflecting layer periodically changes.

As described above, in the case of the reflecting layer having alignment defects or the reflecting layer having an undulation structure, the light diffusibility is excellent.

<Other Members>

The projection member may include another member other than the substrate and the reflecting layer.

For example, an underlayer may be disposed between the substrate and the reflecting layer. By providing the underlayer, the alignment defects of the liquid crystal compound in the reflecting layer can be efficiently formed.

A material constituting the underlayer is not particularly limited and, for example, a resin is preferable. Examples of the resin include well-known resins such as a (meth)acrylic resin, a styrene resin, or a polyolefin resin.

The underlayer may include an alignment controller described below.

In order to improve the light diffusibility of the projection member, a light diffusion layer may be disposed on the reflecting layer. Examples of the light diffusion layer include a layer including the light diffusion element and a binder and a prism sheet having an unevenness shape.

In addition to the above-described members, the projection member may include various members such as a polarization element, an antireflection film, a viewing angle compensation film, an adhesive layer, or an aligned film.

<Projection Device>

The structure of the projection device is not particularly limited as long as the projection device is a device that emits projection light to the above-described projection member. As the projection device, a so-called projector can be used. The projection device may be any device that can emit projection light including any wavelength component.

For example, the projection device may be a three-tube CRT light source that emits three primary color light components of red (R), green (G), and blue (B) from cathode ray tubes (CRT), respectively, or may be a single light source type projection device such as a liquid crystal display (LCD) type or a digital light processing (DLP) type that emits three primary color light components of red (R), green (G), and blue (B) from respective pixels.

As the light source of the projection device, for example, a laser light source, a light-emitting diode (LED), or a discharge tube can be used.

The projection member including one reflecting layer will be described with reference to FIGS. 2 to 5. However, the present invention is not limited to this configuration, and the projection member may include a plurality of reflecting layers.

For example, the projection member may include a reflecting layer that reflects right circularly polarized light and a reflecting layer that reflects left circularly polarized light.

In addition, the projection member may include a plurality of reflecting layers having different reflection center wavelengths. For example, the projection member may include a reflecting layer that reflects light in a blue wavelength range, a reflecting layer that reflects light in a green wavelength range, and a reflecting layer that reflects light in a red wavelength range. This projection member can realize full color display.

Specifically, the blue wavelength range is preferably 430 nm or longer and shorter than 500 nm, the green wavelength range is preferably 500 nm or longer and shorter than 600 nm, and the red wavelength range is preferably 600 nm to 650 nm.

<Method of Manufacturing Projection Member>

As a method of manufacturing the above-described projection member, a well-known method can be adopted without any particular limitation.

In particular, a manufacturing method including the following steps is preferable from the viewpoint of easily controlling the helical pitch of the cholesteric liquid crystalline phase in the reflecting layer.

Step 1: a step of forming a coating film using a composition that includes a liquid crystal compound having a polymerizable group and a chiral agent capable of changing a helical pitch of a cholesteric liquid crystalline phase in response to light, heating the coating film, and aligning the liquid crystal compound to be in a cholesteric liquid crystalline phase state;

Step 2: a step of irradiating the coating film with light to change the helical pitch of the cholesteric liquid crystalline phase in a plane direction of the coating film; and

Step 3: a step of curing the coating film irradiated with light to form a reflecting layer obtained by immobilizing a cholesteric liquid crystalline phase.

Hereinafter, the procedure of the respective steps will be described in detail.

(Step 1)

Step 1 is a step of forming a coating film using a composition that includes a liquid crystal compound having a polymerizable group and a chiral agent capable of changing a helical pitch of a cholesteric liquid crystalline phase in response to light, heating the coating film, and aligning the liquid crystal compound to be in a cholesteric liquid crystalline phase state;

The liquid crystal compound having a polymerizable group and the chiral agent capable of changing a helical pitch of a cholesteric liquid crystalline phase in response to light are as described above.

The composition may include a compound other than the above-described components.

For example, the composition may include a polymerization initiator.

It is preferable that the polymerization initiator is a photopolymerization initiator that can initiate a polymerization reaction by ultraviolet irradiation. Examples of the photopolymerization initiator include an α-carbonyl compound (described in U.S. Pat. Nos. 2,367,661A and 2,367,670A), an acyloin ether (described in U.S. Pat. No. 2,448,828A), an α-hydrocarbon-substituted aromatic acyloin compound (described in U.S. Pat. No. 2,722,512A), a polynuclear quinone compound (described in U.S. Pat. Nos. 3,046,127A and 2,951,758A), a combination of a triaryl imidazole dimer and p-aminophenyl ketone (described in U.S. Pat. No. 3,549,367A), an acridine compound and a phenazine compound (described in JP1985-105667A (JP-S60-105667A) and U.S. Pat. No. 4,239,850A), and an oxadiazole compound (described in U.S. Pat. No. 4,212,970A).

The content of the polymerization initiator in the composition is not particularly limited, and is preferably 0.1 to 20 mass % with respect to the total mass of the liquid crystal compound.

The composition may include an alignment controller. By the composition including the alignment controller, the cholesteric liquid crystalline phase can be rapidly formed.

Examples of the alignment controller include a fluorine-containing (meth)acrylate polymer, compounds represented by Formulae (X1) to (X3) described in WO2011/162291A, and compounds described in paragraphs “0020” to “0031” of JP2013-047204A. The composition may include two or more kinds selected from the above-described examples. These compounds can reduce a tilt angle of the molecules of the liquid crystal compound at the air interface of the layer or can align the molecules substantially horizontally. In this specification, “horizontal alignment” refers to a state where the major axis of the liquid crystal compound is parallel to the film surface but is not required to be exactly parallel. In this specification, “horizontal alignment” refers to an alignment in which the tilt angle with respect to the horizontal surface is less than 20 degrees.

As the alignment controller, one kind may be used alone, or two or more kinds may be used in combination.

The content of the alignment controller in the composition is not particularly limited, and is preferably 0.01 to 10 mass % with respect to the total mass of the liquid crystal compound.

The composition may include a solvent.

Examples of the solvent include water and an organic solvent. Examples of the organic solvent include: an amide such as N,N-dimethylformamide; a sulfoxide such as dimethyl sulfoxide; a heterocyclic compound such as pyridine; a hydrocarbon such as benzene or hexane; an alkyl halide such as chloroform or dichloromethane; an ester such as methyl acetate, butyl acetate, or propylene glycol monoethyl ether acetate; a ketone such as acetone, methyl ethyl ketone, cyclohexanone, or cyclopentanone; an ether such as tetrahydrofuran or 1,2-dimethoxyethane; and 1,4-butanediol diacetate. Among these, one kind may be used alone, or two or more kinds may be used in combination.

The composition may include one additive or two or more additives, for example, an antioxidant, a ultraviolet absorber, a sensitizer, a stabilizer, a plasticizer, a chain transfer agent, a polymerization inhibitor, an antifoaming agent, a leveling agent, a thickener, a flame retardant, a surfactant, a dispersant, or a coloring material such as a dye or a pigment.

(Procedure of Step 1)

Examples of a method of forming the coating film in Step 1 include a step of applying the above-described composition to a substrate. A coating method is not particularly limited, and examples thereof include a wire bar coating method, an extrusion coating method, a direct gravure coating method, a reverse gravure coating method, and a die coating method.

Optionally, the composition applied to the substrate may be dried. By drying the composition, the solvent can be removed from the applied composition.

In addition, examples of the substrate include substrates which may be included in the above-described projection member.

The thickness of the coating film is not particularly limited, and is preferably 0.1 to 20 μm, more preferably 0.2 to 15 μm, and still more preferably 0.5 to 10 μm from the viewpoint of further improving the reflecting properties of the reflecting layer.

Next, the coating film is heated, and the liquid crystal compound in the coating film is aligned to be in a cholesteric liquid crystalline phase state.

From the viewpoint of manufacturing suitability, the liquid crystal phase transition temperature of the composition is preferably 10° C. to 250° C. and more preferably 10° C. to 150° C.

It is preferable that the composition is heated under heating conditions of 40° C. to 100° C. (preferably 60° C. to 100° C.) for 0.5 to 5 minutes (preferably 0.5 to 2 minutes).

(Step 2)

Step 2 is a step of irradiating the coating film in the cholesteric liquid crystalline phase state with light to change the helical pitch of the cholesteric liquid crystalline phase in a plane direction of the coating film; and By performing this step, regions having different helical pitches can be formed in the coating film. More specifically, a change in the structure of the photosensitive chiral agent is induced by light irradiation, which is performed in this step, such that the helical pitch of the cholesteric liquid crystalline phase changes.

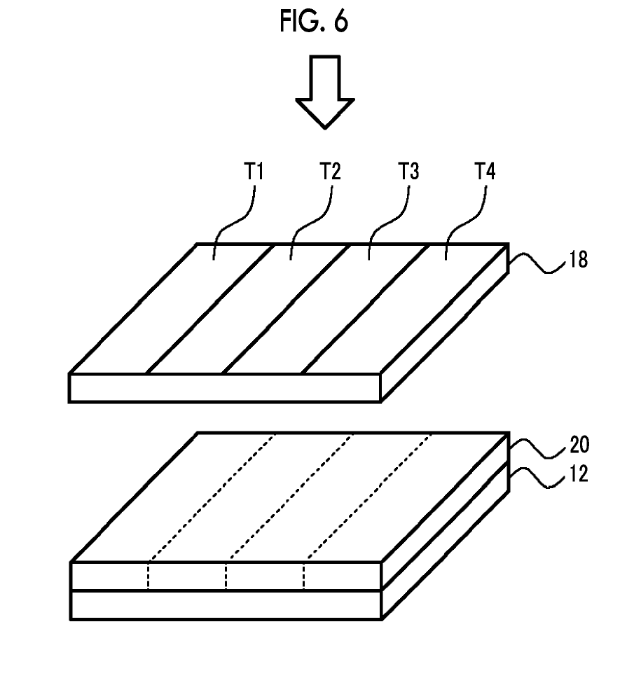

For example, in the configuration in which the reflecting layer 14a shown in FIG. 2 is formed, examples of a specific procedure of this step include a method of irradiating a coating film 20 through a filter 18 as shown in FIG. 6. The filter 18 includes four regions T1 to T4, and the transmittance of light increases in order from the region T1 to the region T4. That is, a region of the coating film 20 positioned below the region T1 is not substantially irradiated with irradiation light such that the helical pitch of the cholesteric liquid crystalline phase does not substantially change. On the other hand, a region of the coating film 20 positioned below the region T4 is irradiated with a large amount of irradiation light such that the helical pitch of the cholesteric liquid crystalline phase increases. That is, the exposure dose at which the coating film 20 is irradiated through the filter 18 can be controlled, and thus the helical pitch of the cholesteric liquid crystalline phase in the coating film 20 can be controlled.

In a case where the reflecting layer 14a shown in FIG. 2 is manufactured, the structure of the filter is not limited to this configuration. For example, by using a filter in which the light transmittance increases from a center portion to an end portion, the reflecting layer 14b shown in FIG. 4 can be manufactured.

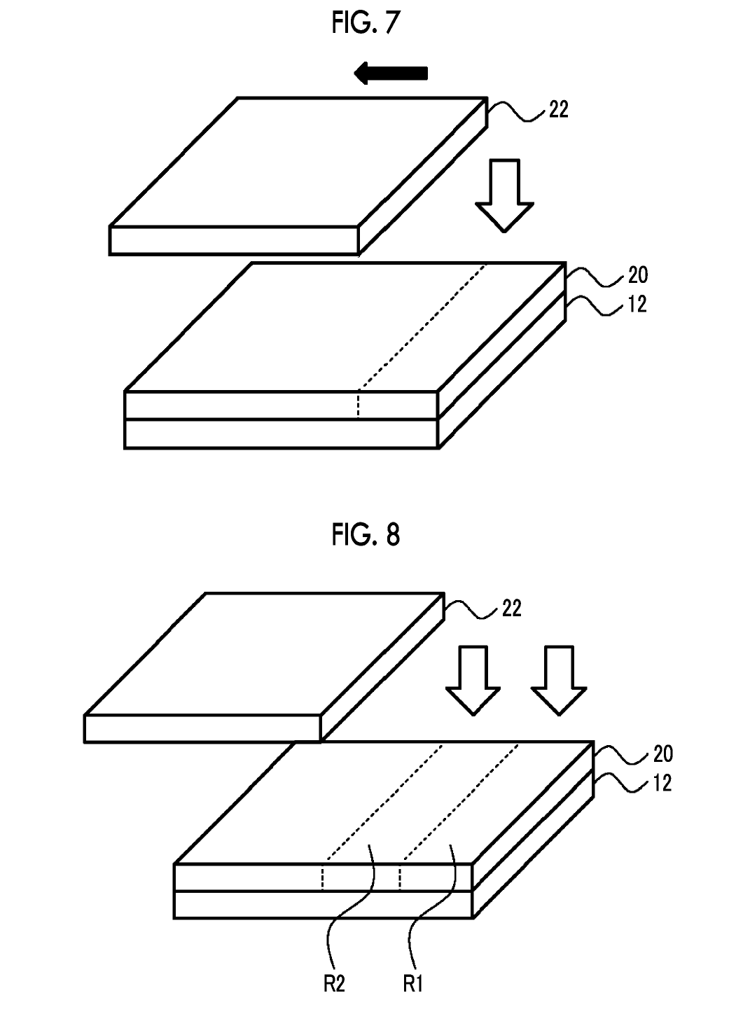

In addition, examples of another method of Step 2 include a method of irradiating the coating film 20 with light while shifting a mask 22 as shown in FIGS. 7 and 8.

As shown in FIG. 7, the mask 22 is disposed such that only a part of the region of the coating film 20 is irradiated with light, and then the coating film is irradiated with light. Next, the mask 22 is moved in a direction indicated by a black arrow, and then the coating film 20 is irradiated with light again as shown in FIG. 8. In this case, a region R1 shown in FIG. 8 is irradiated with light twice, a change in the structure of the chiral agent is further induced. As a result, in the region R1, the helical pitch of the cholesteric liquid crystalline phase is larger than that in a region R2. By repeating this operation, the reflecting layer shown in FIG. 2 can be obtained.

In the above description, the configuration in which the mask 22 is moved stepwise has been described. However, the present invention is not limited to this configuration. For example, by irradiating the coating film 20 with light while continuously moving the mask 22, the helical pitch of the cholesteric liquid crystalline phase can be continuously changed in a plane direction of the coating film 20.

In addition, in the above description, the configuration in which the helical pitch increases as the light irradiation dose increases has been described. However, by changing the kind of the photosensitive chiral agent, a configuration in which the helical pitch decreases as the light irradiation dose increases can also be adopted.

The wavelength at which light is irradiated in this step is not particularly limited as long as it is a wavelength at which a change in the structure of the photosensitive chiral agent can be induced (a wavelength at which the photosensitive chiral agent is photosensitive).

In a case where the composition includes a polymerization initiator, it is preferable that the composition is exposed to light at a wavelength at which the polymerization initiator is not likely to be photosensitive.

(Step 3)

Step 3 is a step of curing the coating film irradiated with light to form a reflecting layer obtained by immobilizing a cholesteric liquid crystalline phase.

A curing method is not particularly limited, and examples thereof include a photocuring treatment and a thermal curing treatment. In particular, a light irradiation treatment is preferable, and an ultraviolet irradiation treatment is more preferable.

For the ultraviolet irradiation, a light source such as an ultraviolet lamp is used.

The irradiation energy dose of ultraviolet light is not particularly limited and, in general, is preferably about 0.1 to 0.8 J/cm². In addition, a period of time in which ultraviolet light is irradiated is not particularly limited and may be appropriately determined from the viewpoints of the strength and productivity of the obtained reflecting layer.

<Use>

The projection member according to the present invention can be used, for example, a projection screen or a half mirror for displaying a projection image.

The projection member according to the present invention can recognizably display an image projected from a projector, and in a case where the projection member is observed from the same surface side as the surface where the image is displayed, information or scenery on the opposite side can be observed at the same time.

### EXAMPLES

Hereinafter, the characteristics of the present invention will be described in detail using Examples and Comparative Examples. Materials, used amounts, ratios, treatment details, treatment procedures, and the like shown in the following Examples can be appropriately changed within a range not departing from the scope of the present invention. Accordingly, the scope of the present invention is not limited to the following specific examples.

(Preparation of Polymerizable Composition Coating Solution A)

The following components were mixed with each other to prepare a polymerizable composition coating solution A.

BLEMMER 758: 100 parts by mass

Air interface alignment agent (A-2): 0.02 parts by mass

Polymerization initiator Irg819 (manufactured by BASF SE): 3 parts by mass

Methyl ethyl ketone (MEK): 200 parts by mass

Air Interface Alignment Agent (A-2) (the Following Structure)

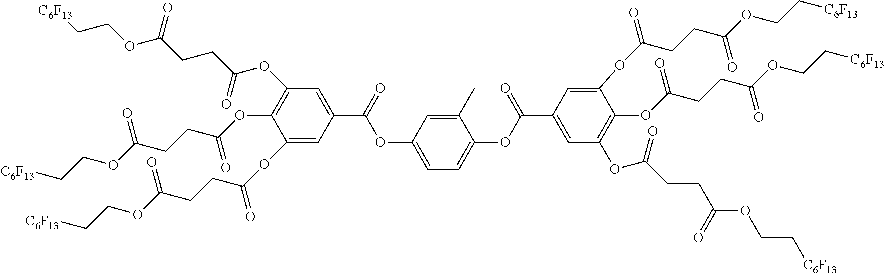

(Preparation of Polymerizable Composition Coating Solution 1)

The following components were mixed with each other to prepare a polymerizable composition coating solution 1.

Compound (M-1): 84 parts by mass

Compound (M-2): 15 parts by mass

Compound (M-3): 1 part by mass

Chiral agent LC-756 (manufactured by BASF SE): 3.6 parts by mass

Chiral agent (A-1): 1.4 parts by mass

Air interface alignment agent (A-2): 0.02 parts by mass

Polymerization initiator Irg819 (manufactured by BASF SE): 3 parts by mass

Compound (M-1) (the Following Structure)

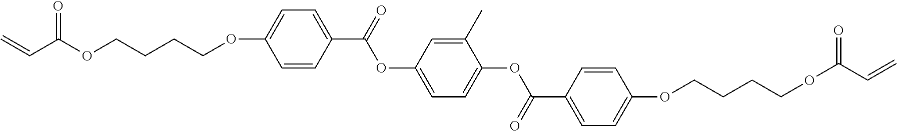 [SMILES: C=CC(=O)OCCCCOc1ccc(C(=O)Oc2ccc(OC(=O)c3ccc(OCCCCOC(=O)C=C)cc3)c(C)c2)cc1]

Compound (M-2) (the Following Structure)

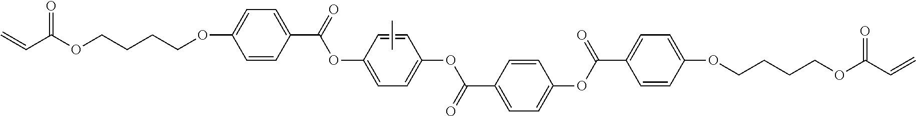

Compound (M-3) (the Following Structure)

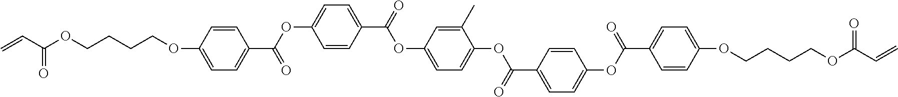 [SMILES: C=CC(=O)OCCCCOc1ccc(C(=O)Oc2ccc(C(=O)Oc3ccc(OC(=O)c4ccc(OC(=O)c5ccc(OCCCCOC(=O)C=C)cc5)cc4)c(C)c3)cc2)cc1]

Chiral Agent (A-1) (the Following Structure)

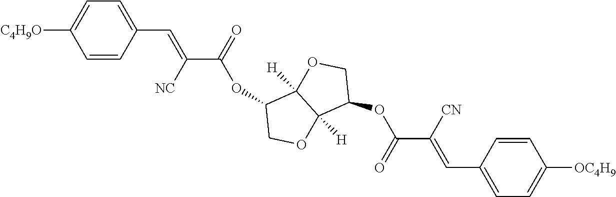

(Polymerizable Composition Coating Solution 2)

The following components were mixed with each other to prepare a polymerizable composition coating solution 2.

Compound (M-1): 100 parts by mass

Chiral agent LC-756 (manufactured by BASF SE): 4.8 parts by mass

Air interface alignment agent (A-2): 0.02 parts by mass

Polymerization initiator Irg819 (manufactured by BASF SE): 3 parts by mass

MEK: 200 parts by mass

### Example 1

The polymerizable composition coating solution A was applied to a polyethylene terephthalate (PET) substrate (manufactured by Fuji Film Co., Ltd., thickness: 75 μm) using a wire bar at room temperature such that the thickness of the dried film was 5 μm. The obtained coating film was dried at room temperature for 30 seconds and then was heated in an atmosphere of 85° C. for 2 minutes. Next, the coating film was irradiated with ultraviolet light at 30° C. for 6 seconds with an output of 60% of a (UV) using a D bulb (lamp 90 mW/cm², manufactured by Fusion UV Systems) to obtain an acrylic layer (corresponding to the underlayer).

Next, the polymerizable composition coating solution 1 was applied to the acrylic layer using a wire bar at room temperature such that the thickness of the dried film thickness was 4.0 μm. The obtained coating film was dried at room temperature for 30 seconds and then was heated in an atmosphere of 85° C. for 1 minute to align the liquid crystal compound.

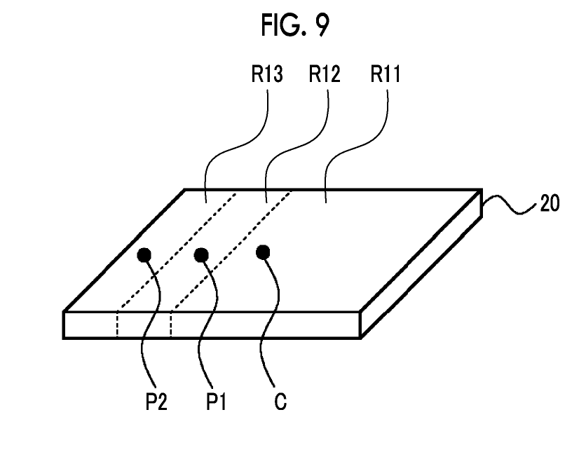

Next, the coating film was exposed to light using a 365 nm band pass filter at 30° C. such that the light exposure dose of a portion corresponding to an end portion for use as a screen is strong (refer to FIG. 6). Specifically, as shown in FIG. 9, the exposure was performed such that an exposure dose at a position P1 at a distance 30 cm of from a center C of the screen and an exposure dose at a position P2 at a distance of 75 cm from the center C of the screen were as shown in Table 1 described below. Each of three regions (R11, R12, R13) of partitioned by broken lines in FIG. 9 was irradiated with light using the band pass filter such that the exposure dose was the same in the same region. More specifically, the exposure dose in the region R11 including the center C was 0, the exposure dose in the region R12 including the position P1 was 5 mW/cm², and the exposure dose in the region R13 including the position P2 was 15 mW/cm².

Next, the exposed coating film was irradiated with UV light at 40° C. for 5 seconds with an output of 100% of the D bulb (lamp 90 mW/cm², manufactured by Fusion UV Systems) without using the filter. As a result, a reflecting layer 1 (corresponding to the layer obtained by immobilizing a cholesteric liquid crystalline phase) was formed.

The reflecting layer 1 partially included alignment defects, and thus had a scattering effect (light diffusion effect).

Using a spectrophotometer V-670 (manufactured by JASCO Corporation), a reflection center wavelength at a predetermined position of the reflecting layer 1 was obtained. The results are shown in Table 1 below. As shown in Table. 1, in the reflecting layer 1, the reflection center wavelength increased as the distance from the center increased.

The reflectivity was measured using an absolute reflectivity measuring unit ARV474S in combination. In addition, the following reflection center wavelength refers to a center wavelength of a reflection peak in a case where light was incident from a position with an inclination angle of 5 degrees with respect to a normal direction perpendicular to the reflecting layer surface.

TABLE 1

| | | Reflection Center |
|---|---|---|
| Distance from | Exposure | Wavelength at Incidence |
| Position corresponding | Dose | Angle: 5 Degrees |
| to Center of Screen | [mW/cm²] | [nm] |
| 0 cm | 0 | 540 nm |
| 30 cm | 5 | 555 nm |
| 75 cm | 15 | 577 nm |

### Comparative Example 1

Next, the polymerizable composition coating solution 2 was applied to an acrylic layer, which was prepared using the same method as in Example 1, using a wire bar at room temperature such that the thickness of the dried film thickness was 4.0 μm. The obtained coating film was dried at room temperature for 10 seconds and then was heated in an atmosphere of 85° C. for 1 minute. Next, the coating film was irradiated with UV light at 40° C. for 5 seconds with an output of 100% of the D bulb (lamp 90 mW/cm², manufactured by Fusion UV Systems). As a result, a reflecting layer 2 was obtained.

Using a spectrophotometer V-670 (manufactured by JASCO Corporation), a reflection center wavelength at a predetermined position of the reflecting layer 2 was obtained. The results are shown in Table 2 below.

<Evaluation>

Each of the reflecting layers 1 and 2 was used as a screen, a projector (WB-546T, manufactured by Seiko Epson Corporation) was disposed at a distance of 72 cm from a screen center portion, and a green image was projected. Then, changes in tint were compared to each other.

“Incidence Angle of Projection Light” in Table 2 refers to an angle between a straight line and a normal line perpendicular to the screen surface, the straight line being obtained by connecting a position where the projector was provided and respective positions on the screen to each other.

In addition, in Table 2, “Reflection Wavelength at Projection Angle” refers to a wavelength of reflected light among the light components incident on the respective positions at “Incidence Angle of Projection Light”.

In the reflecting layer 1, the reflection wavelength at a center portion of the screen and the reflection wavelength at an end portion of the screen (position at a large distance from the center) were substantially the same, and there was substantially no change in the tint of the projection light.

On the other hand, in the reflecting layer 2 according to Comparative Example, at the end portion of the screen, it was found that a significant change in tint from green to bluish green was observed, and the image itself also became dark.

TABLE 2

| | | | Reflection | | | |
|---|---|---|---|---|---|---|
| | | | Center Wave- | | | Reflection |
| | Distance | | length at | Incidence | | Wavelength |
| | from | | Incidence | Angle of | | at Projection |
| | Center of | | Angle: 5 | Projection | | Angle |
| | Screen | | Degrees | Light | | [nm] |
| Example 1 | 0 | cm | 540 nm | 0 | Degrees | 538 nm |
| | 30 | cm | 555 nm | 26 | Degrees | 542 nm |
| | 75 | cm | 577 nm | 46 | Degrees | 543 nm |
| Comparative | 0 | cm | 541 nm | 0 | Degrees | 540 nm |
| Example 1 | 30 | cm | 541 nm | 26 | Degrees | 528 nm |
| | 75 | cm | 541 nm | 46 | Degrees | 505 nm |

By performing the exposure while gradually changing the position of the mask as shown in FIG. 8 instead of the configuration in which the 365 nm band pass filter was used in Example 1, a reflecting layer in which the helical pitch of the cholesteric liquid crystalline phase changed from one end to another end as shown in FIG. 2 was prepared. The projector was disposed as shown in FIG. 3 and projected a green image to the obtained reflecting layer. In the reflecting layer, the reflection wavelength at a center portion of the screen and the reflection wavelength at an end portion of the screen (position at a large distance from the center) were substantially the same, and there was substantially no change in the tint of the projection light.

In addition, by performing the exposure using a filter so as to obtain a reflecting layer in which the helical pitch of the cholesteric liquid crystalline phase changed from the center portion to the end portion as shown in FIG. 4 instead of the configuration in which the 365 nm band pass filter was used in Example 1, a reflecting layer shown in FIG. 4 was prepared. The projector was disposed as shown in FIG. 5 and projected a green image to the obtained reflecting layer. In the reflecting layer, the reflection wavelength at a center portion of the screen and the reflection wavelength at an end portion of the screen (position at a large distance from the center) were substantially the same, and there was substantially no change in the tint of the projection light.

### EXPLANATION OF REFERENCES

10a, 10b, 100: projection member
12: substrate
14a, 14b: reflecting layer
16, 102: projection device
18: filter
20: coating film
22: mask
50a, 50b: projection system

What is claimed is:

1. A projection member comprising:
a reflecting layer that is obtained by immobilizing a cholesteric liquid crystalline phase,
wherein a helical pitch of the cholesteric liquid crystalline phase gradually changes in a plane direction of the reflecting layer.

2. The projection member according to claim 1,
wherein the helical pitch of the cholesteric liquid crystalline phase gradually increases from a center portion of the reflecting layer to an end portion of the reflecting layer.

3. The projection member according to claim 1,
wherein the helical pitch of the cholesteric liquid crystalline phase gradually changes from one end of the reflecting layer to another end of the reflecting layer.

4. The projection member according to claim 1,
wherein the helical pitch of the cholesteric liquid crystalline phase increases on a surface of the reflecting layer as a distance from a projection light emitting opening of a projection device disposed distant from the surface of the reflecting layer increases.

5. The projection member according to claim 1,
wherein the reflecting layer has light diffusibility.

6. The projection member according to claim 5,
wherein the reflecting layer includes a light diffusion element.

7. The projection member according to claim 1, further comprising:
a light diffusion layer that is provided on the reflecting layer.

8. The projection member according to claim 1,
wherein a plurality of the reflecting layers having different reflection center wavelengths are provided.

9. A projection system comprising:
the projection member according to claim 1; and
a projection device that emits projection light to the projection member.

10. A method of manufacturing the projection member according to claim 1, the method comprising:
a step of forming a coating film using a composition that includes a liquid crystal compound having a polymerizable group and a chiral agent capable of changing a helical pitch of a cholesteric liquid crystalline phase in response to light, heating the coating film, and aligning the liquid crystal compound to be in a cholesteric liquid crystalline phase state;
a step of irradiating the coating film with light to change the helical pitch of the cholesteric liquid crystalline phase in a plane direction of the coating film; and
a step of curing the coating film irradiated with light to form a reflecting layer obtained by immobilizing a cholesteric liquid crystalline phase.

11. The projection member according to claim 2,
wherein the helical pitch of the cholesteric liquid crystalline phase increases on a surface of the reflecting layer as a distance from a projection light emitting opening of a projection device disposed distant from the surface of the reflecting layer increases.

12. The projection member according to claim 3,
wherein the helical pitch of the cholesteric liquid crystalline phase increases on a surface of the reflecting layer as a distance from a projection light emitting opening of a projection device disposed distant from the surface of the reflecting layer increases.
